(19) United States
(12) Patent Application Publication
(10) Pub. No.: US 2007/0090664 A1
(43) Pub. Date: Apr. 26, 2007

(54) HARDTOP VEHICLE ROOF WITH EXTERNAL ROOF KINEMATIC SYSTEM

(75) Inventor: Wojciech Wezyk, Sindelfingen (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/553,243

(22) Filed: Oct. 26, 2006

(30) Foreign Application Priority Data
Oct. 26, 2005 (DE) 10 2005 051 648.3

(51) Int. Cl. B60J 7/14

(52) U.S. Cl. 296/107.17

(57) ABSTRACT

A hardtop vehicle roof includes roof parts and kinematic mechanisms. The parts are movable between a closed position covering a vehicle interior and a storage position exposing the interior. Each part has an exterior surface facing away from the interior in the closed position. Each part has first and second longitudinally extending sides. One of the mechanisms articulately connects the first sides of two of the parts together and the other of the mechanisms articulately connects the second sides of the two parts together to move the two parts between the closed and storage positions. In the closed position the two parts are arranged flush behind one another in the longitudinal direction with a first part arranged in front of a second two part. In the closed position the mechanisms are respectively arranged on sides of the exterior surface of the second part.

### CROSS-REFERENCE TO RELATED APPLICATIONS

This application claims foreign priority benefits under 35 U. S. C. § 119(a)-(d) to DE 10 2005 051 648.3, filed Oct. 26, 2005, which is hereby incorporated by reference in its entirety.

### BACKGROUND OF THE INVENTION

1. Field of the Invention

The present invention relates to a hardtop vehicle roof having a plurality of roof parts in which the roof parts are movable to move between closed and storage positions of the roof.

2. Background Art

EP 1 463 647 B1 (corresponding to U.S. Patent Application Publication No. 2005/0156449) describes a hardtop vehicle roof having three rigid roof parts. Kinematic systems pivot the front and rear roof parts relative to the middle roof part. An adjustment kinematic system pivots the middle roof part relative to the vehicle body. In the storage position of the roof, the roof parts are laid in the same direction in a stack within a storage compartment of the vehicle. Because the roof parts are stacked with the front and rear roof parts stored above the middle roof part, the middle roof part maintains its position while the roof parts are being stacked. As such, the roof part stacking does not encroach the vehicle interior. However, the kinematic systems consume a relatively large amount of space within the vehicle interior. As such, passenger headroom is relatively limited when the roof is in the closed position covering the vehicle interior.

DE 41 00 677 C2 (corresponding to U.S. Patent Ser. No. 5,078,447) describes a vehicle roof having two roof parts. The front roof part is adjustable between closed and opened positions. To accomplish such adjustment, four-bar kinematic systems mount the front roof part on side supports. The side supports are movable in retaining channels in the rear roof part. The retaining channels are open on their top side. When the roof is in the closed position covering the vehicle interior, the side supports, which are part of the kinematic systems, are located in the vehicle interior and thus encroach upon passenger headroom.

### SUMMARY OF THE INVENTION

An object of the present invention is a hardtop vehicle roof having multiple roof parts movable by a roof kinematic system between a closed position of the roof in which the roof parts cover the vehicle interior and a stored position of the roof in which the roof parts are stacked upon one another and stored within a storage compartment of the vehicle thereby exposing the vehicle interior in which the roof kinematic system does not encroach upon the vehicle interior when the roof is in the closed position.

In carrying out the above object and other objects, the present invention provides a hardtop vehicle roof. The roof includes at least two roof parts movable between a closed position in which the roof parts are arranged flush behind one another in a longitudinal direction to thereby cover a vehicle interior and a storage position in which the roof parts are arranged in a stack to thereby expose the vehicle interior. Each roof part has an exterior surface facing away from the vehicle interior in the closed position. Each roof part has first and second longitudinally extending sides transversely separated from one another. The roof further includes a first pair of roof part kinematic systems transversely separated from one another. One of the roof part kinematic systems articulately connecting the first sides of two of the roof parts together and the other of the roof part kinematic systems articulately connecting the second sides of the two roof parts together to move the two roof parts between the closed and storage positions. In the closed position the two roof parts are arranged flush behind one another in the longitudinal direction with a first one of the two roof parts arranged in front of a second one of the two roof parts. In the closed position the roof part kinematic systems are respectively arranged on the exterior surface of the second roof part on the sides of the second roof part.

In carrying out the above object and other objects, the present invention provides another hardtop vehicle roof. This roof includes at least two roof parts movable between a closed position in which the roof parts are arranged flush behind one another in a longitudinal direction to thereby cover a vehicle interior and a storage position in which the roof parts are arranged in a stack to thereby expose the vehicle interior. Each roof part has an exterior surface facing away from the vehicle interior in the closed position. Each roof part has first and second longitudinally extending sides transversely separated from one another. This roof further includes a roof part kinematic system articulately connecting two of the roof parts together to move the two roof parts between the closed and storage positions. In the closed position the two roof parts are arranged flush behind one another in the longitudinal direction with a first one of the two roof parts arranged in front of a second one of the two roof parts. In the closed position the roof part kinematic system is arranged on the exterior surface of the second roof part on the sides of the second roof part.

In carrying out the above object and other objects, the present invention provides a hardtop vehicle roof This roof includes at least two roof parts movable between a closed position in which the roof parts are arranged flush behind one another in a longitudinal direction to thereby cover a vehicle interior and a storage position in which the roof parts are arranged in a stack to thereby expose the vehicle interior. Each roof part has an exterior surface facing away from the vehicle interior in the closed position. Each roof part has first and second longitudinally extending sides transversely separated from one another. This roof further includes a roof part kinematic system articulately connecting two of the roof parts together to move the two roof parts between the closed and storage positions. In the closed position the two roof parts are arranged flush behind one another in the longitudinal direction with a first one of the two roof parts arranged in front of a second one of the two roof parts. In the closed position the roof part kinematic system is arranged on the exterior surface of the second roof part on the longitudinal central axis of the second roof part.

In accordance with an embodiment of the present invention, a roof kinematic system is configured to move a vehicle roof having multiple roof parts between a closed position in which the roof parts cover the vehicle interior and a stored position in which the roof parts are stacked upon one another and moved away from the roof level of the vehicle to expose the vehicle interior. The roof kinematic system generally includes a roof part kinematic system for each pair of roof parts. Each roof part kinematic system articulately connects a pair of roof parts together and is operable to move the roof parts relative to one another and to the vehicle interior in order to move the roof between its closed and stored positions. Each roof part kinematic system for a pair of roof parts effectively includes a roof part kinematic system on each of the two longitudinal sides of the roof. The roof kinematic system (i.e., all of the roof part kinematic systems) is located outside of the vehicle interior. The roof part kinematic systems movably guide the respective roof parts from the outside of the vehicle interior. As such, the kinematic elements of the roof kinematic system do not have contact with the passenger area of the vehicle interior thereby resulting in more headroom for passengers. The configuration of the roof kinematic system increases passenger safety because in the event of an accident the kinematic elements do not deform inside the vehicle interior thereby making it possible to avoid passenger injuries due to kinematic elements deforming. When the roof parts are in the closed position of the roof, the roof part kinematic systems are supported on the outside of the roof or at least to rest partly on the outside of the roof.

In an embodiment of the present invention, to improve the overall esthetic impression, when the roof is in the closed position, the roof part kinematic systems are held in respective retaining channels provided on the exterior surface of the sides of respective roof parts. The retaining channels run in the vehicle's longitudinal direction and are open on their tops. Depending on the height of the retaining channels, the roof part kinematic systems are not visible when the roof is in the closed position. Rather, the roof part kinematic systems are held on the exterior surface of respective roof parts inside the retaining channels arranged in these roof parts. Storing the roof part kinematic systems in retaining channels allows the roof part kinematic systems to absorb energy together with the roof parts and allows the roof part kinematic systems to deform together with the roof parts. This also increases the stability of the roof.

In an embodiment of the present invention, the depth of the retaining channels are dimensioned such that the roof part kinematic systems can be lowered completely inside the retaining channels. The retaining channels may also be made extremely flat such that only a single retaining channel on each of the two sides of the roof.

In an embodiment of the present invention, each retaining channel is formed into a respective roof part. This means that each retaining channel is not raised with respect to the surface of the roof part or is raised only slightly. It is also unnecessary to mount a separate component on the outside of the roof. In the closed position of the roof, the roof part kinematic systems are hidden from sight within the retaining channels on the outside of the roof.

In an embodiment of the present invention, each retaining channel extends from a front edge, pointing in the forward direction of vehicle travel, to a back edge, pointing in the rearward direction of vehicle travel, of a respective roof part in order to allow the roof part kinematic systems to pivot in as large an area as possible.

In an embodiment of the present invention, the esthetic image of the roof is improved by respectively covering the retaining channels with movable covers. Especially in the closed position of the roof, the covers cover the retaining channels such that the roof part kinematic systems located therein are hidden from sight. The closing of the retaining channels simultaneously avoids the negative effects of the weather on the roof part kinematic systems. Each cover is mounted on a roof part so that the cover can fold or slide, for example, with the retaining channel of the roof part.

In an embodiment of the present invention, the opening and closing movements of the covers with respect to the respective retaining channels are coupled with the opening and closing movements of the roof part kinematic systems. As such, for example, at the beginning of the opening movement of a roof part the associated retaining channels (i.e., the retaining channels on respective outer sides of the roof part) are opened and the retaining channels are forced closed at the end of the closing movement of the roof part. Each cover may include at least one pivot axis running in the longitudinal direction of the vehicle to pivot between its opened and closed position with respect to the respective retaining channel.

In an embodiment of the present invention, the roof part kinematic systems move the roof parts in a stack lying on top of one another when moving the roof to its stored position such that the roof part stack may be stored in a space-saving manner. If each roof part kinematic system is in the form of a link arrangement, then the links of the roof part kinematic system may pivot on the outside of respective roof parts. The links may pivot inside the retaining channels of the respective roof parts. Any brackets for enabling the pivoting may also be arranged within the retaining channels to be hidden from sight. In the closed position of the roof, the links run approximately parallel to the outer sides of the roof in the longitudinal direction of the vehicle. The pivoting movement of the roof part kinematic systems takes place entirely outside of the vehicle interior.

In an embodiment of the present invention, the links of the roof part kinematic systems pivot on respective pivoting extensions of the roof parts. The pivoting extensions of a given roof part project over the roof part lying adjacent to the given roof part in the rearward direction of the vehicle. For instance, the pivoting extensions of the front roof part project over the middle roof part. In the closed position of the roof, the pivoting extensions of a given roof part may lie on the exterior surface of the adjacent roof part, preferably within the respective retaining channels of the adjacent roof part. For instance, in the closed position of the roof, the pivoting extensions of the front roof part lie on the exterior surface of the middle roof part within the respective channels of the middle roof part. In particular, in this example, the pivoting extensions of the front roof part are supported on the outside of the middle roof part, preferably within the respective retaining channels of the middle roof part thereby increasing the stability of the roof, especially in the closed position of the roof.

In accordance with an embodiment of the present invention, each pivoting extension includes a cover strip. The cover strip are arranged above the pivot points of the links of the respective roof part kinematic systems and close off the top sides of the respective pivoting extensions. The cover strips are intended to close the respective retaining channels when the roof parts are in the closed position of the roof. The pivoting extensions close the respective retaining channels in the closed position by the cover strips. In these areas, no separate closing covers are required to close the respective retaining channels.

In an embodiment of the present invention, each roof part kinematic system includes a drive for driving the roof part kinematic system to move the roof parts associated with the roof part kinematic system. Each drive is respectively arranged between the outside of a roof part and the inner panel of the roof part. As such, the drives are arranged beneath the outside of the roof such that the drives are protected from rain and the like. Further, as such, the drives do not project into the vehicle interior. Rather, the drives are hidden from sight by the inner panels of the respective roof parts. The drives are sandwiched within the respective roof parts.

In an embodiment of the present invention, the roof parts are relatively flat and the drives are in the form of rotary actuators.

A plurality of different possible adjustments is obtained if each roof part kinematic system includes a multiple-bar kinematic system such as a four-bar kinematic system. It is advantageous if in the closed position of the roof, the multiple-bar kinematic systems are concealed within respective retaining channels located on the outside of respective roof parts.

In an embodiment of the present invention, a multiple-bar kinematic system such as a four-bar kinematic system pivots centrally, when viewed in the transverse direction of the vehicle, on a pair of adjacent roof parts. It is preferable for the force to be applied through this multiple-bar kinematic system located on the longitudinal central axis of the roof. Support links at the side of the central multiple-bar kinematic system articulately connect adjacent roof parts with one another.

In an embodiment of the present invention, each roof part kinematic system includes two multiple-bar kinematic systems such as four-bar kinematic systems. Each multiple-bar kinematic system of a roof part kinematic system are transversely separated from one another and are located on respective sides of the roof. The two multiple-bar kinematic systems of a roof part kinematic system have a symmetrical configuration and are symmetrically arranged on respective sides of the roof.

In an embodiment of the present invention, each roof part kinematic system includes a single four-bar kinematic system. The single four-bar kinematic system is formed from two separated individual links. This reduces the number of components in a roof part kinematic system to a minimum.

In an embodiment of the present invention, the two individual links of a single four-bar kinematic system are separated from one another in the longitudinal and transverse directions of the vehicle. In this case, it is not necessary to lay the links on top of one another which thereby allows the respective retaining channel for holding the links to be flatter.

In an embodiment of the present invention, one individual link is arranged for each of the two side areas of a roof part. The pivots points of the individual links of one roof part and the pivot points of the individual links of another roof part are arranged offset to one another in the longitudinal direction of the vehicle. The links, which are rotatable, are configured to accept forces acting in the transverse direction of the vehicle.

In an embodiment of the present invention, the individual links of a single four-bar kinematic system are separated from one another only in the longitudinal direction of the vehicle and are arranged on the longitudinal central axis of the roof. This embodiment does without side support links. Adjacent roof parts are connected with one another through the two individual links.

In an embodiment of the present invention, the roof is a hardtop vehicle roof having three roof parts. The roof parts include front, middle, and rear roof parts. The roof parts are folded in a stack when the roof is in the stored position.

In an embodiment of the present invention in which the roof has three roof parts, the middle roof part includes a first pair of retaining channels on respective sides of the middle roof part and the rear roof part includes a second pair of retaining channels on respective sides of the rear roof part. A first (i.e., front) kinematic system is arranged between the front and middle roof parts and is articulately connected to the front and middle roof parts. The front kinematic system includes a pair of front roof part kinematic systems on each longitudinal side of the roof. A second (i.e., rear) kinematic system is arranged between the middle and rear roof parts and is articulately connected to the middle and rear roof parts. The rear kinematic system includes a pair of rear roof part kinematic systems on each longitudinal side of the roof. The first pair of retaining channels in the middle roof part serve to hold the front roof part kinematic systems. The second pair of retaining channels in the rear roof part serve to hold the rear roof part kinematic systems.

In an embodiment of the present invention in which the roof has three roof parts, the links of each front roof part kinematic system pivot at one end on the exterior surface of the middle roof part and at the other end on pivoting extensions on the front roof part. The front roof part includes a pivoting extension on each of its two outer longitudinal sides. The pivoting extensions point from the front roof part to the middle roof part. The links of the front roof part kinematic systems pivot within respective retaining channels on the outer longitudinal sides of the middle roof part. The pivoting extensions on the front roof part are respectively held within the retaining channels of the middle roof part when the roof is in the closed position.

The rear roof part kinematic systems are analogously arranged. The links of each rear roof part kinematic system pivot at one end on the exterior surface of the rear roof part and at the other end on pivoting extensions on the middle roof part. The middle roof part includes a pivoting extension on each of its two outer longitudinal sides. The pivoting extensions point from the middle roof part to the rear roof part. The links of the rear roof part kinematic systems pivot within respective retaining channels on the outer longitudinal sides of the rear roof part. The pivoting extensions on the rear roof part are respectively held within the retaining channels of the rear roof part when the roof is in the closed position.

The front and rear roof part kinematic systems are operable to lay the roof parts together into a stack. In the storage position of the roof, the roof parts are laid in the stack in the same direction with their exterior surfaces pointing upward.

In an embodiment of the present invention in which the roof has three roof parts, the front roof part kinematic systems between the front and middle roof parts pivot on the respective longitudinal sides of the middle roof part when the front roof part kinematic systems are in the closed position. The front roof part kinematic systems pivot within respective retaining channels on the longitudinal sides of the middle roof part. Additionally, the links of the front roof part kinematic systems are articulately connected with respective pivoting extensions of the front roof part. The front and middle roof parts are laid in the roof part stack in the same direction with their exterior surfaces pointing upward when the roof is in the storage position. The rear roof part is laid at the bottom of the stack in the opposite direction to the other roof part with its exterior surface pointing downward when the roof is in the storage position.

In an embodiment of the present invention, in order to stow the stack of roof parts in as space-saving a way as possible, the roof part stack is stored in a storage compartment with a convertible top compartment cover.

In an embodiment of the present invention, one or more of the roof parts have a built-in sunroof. The sunroof may be opened when the roof or roof parts are in the closed position. Thus, it is possible to select whether to operate the roof as a sunroof, a convertible, or a coupe.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a hardtop vehicle roof having front, middle, and rear roof parts in accordance with a first embodiment of the present invention with the roof being in a closed position covering the vehicle interior;

FIG. 2 illustrates a section view of the middle roof part along the line A-A of FIG. 1;

FIG. 3 illustrates the retaining channels arranged on the outside of the middle and rear roof parts for the front and rear roof part kinematic systems with the roof being in the closed position;

FIG. 4 illustrates the roof in a first intermediate position between the closed position and a storage position of the roof;

FIG. 5 illustrates the roof in a second intermediate position more advanced to the storage position than the first intermediate position shown in FIG. 4;

FIG. 6 illustrates the roof in a third intermediate position more advanced to the storage position than the second intermediate position shown in FIG. 5;

FIG. 7 illustrates a sectional view along the line A-A of FIG. 6 with the roof being in the closed position;

FIG. 8 illustrates the roof in a fourth intermediate position more advanced to the storage position than the third intermediate position and shortly before reaching the storage position;

FIG. 9 illustrates the roof in the storage position with the roof parts being stacked in the same direction and stowed in a storage compartment;

FIG. 10 illustrates a hardtop vehicle roof having front, middle, and rear roof parts in accordance with a second embodiment of the present invention with the roof being in an intermediate position between closed and storage positions;

FIG. 11 illustrates a sectional view along the line A-A in FIG. 10;

FIG. 12 illustrates a hardtop vehicle roof having front, middle, and rear roof parts in accordance with a third embodiment of the present invention;

FIG. 13 illustrates the roof in accordance with the third embodiment in an intermediate position between the closed and storage positions;

FIG. 14 illustrates the roof in accordance with the third embodiment in the storage position within a storage compartment having a convertible top compartment cover;

FIG. 15 illustrates a hardtop vehicle roof having front, middle, and rear roof parts in accordance with a fourth embodiment of the present invention;

FIG. 16 illustrates an enlargement of the roof in accordance with the fourth embodiment; and

FIG. 17 illustrates a hardtop vehicle roof having front, middle, and rear roof parts in accordance with a fifth embodiment of the present invention in which the roof includes built-in sunroof parts.

### DETAILED DESCRIPTION OF THE PREFERRED EMBODIMENT(S)

In the figures, elements that are the same and elements having the same function are labeled with the same reference numbers.

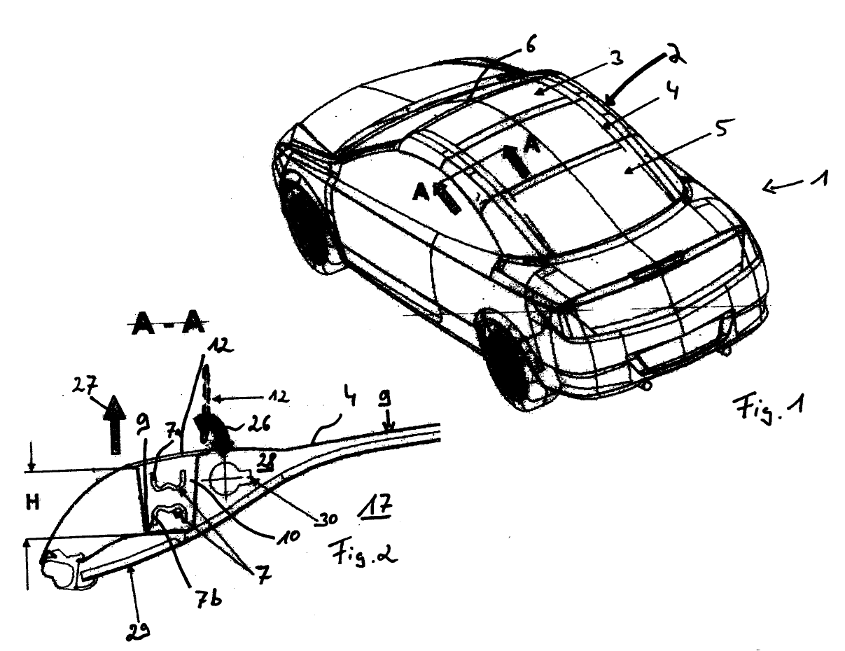

Referring now to FIGS. 1 through 9, a hardtop roof 2 for a vehicle in accordance with a first embodiment of the present invention is shown. Roof 2 is a three-part roof having rigid roof parts. The roof parts include a front roof part 3, a middle roof part 4, and a rear roof part 5. Front and middle roof parts 3, 4 are articulately connected to one another. Likewise, middle and rear roof parts 4, 5 are articulately connected to one another.

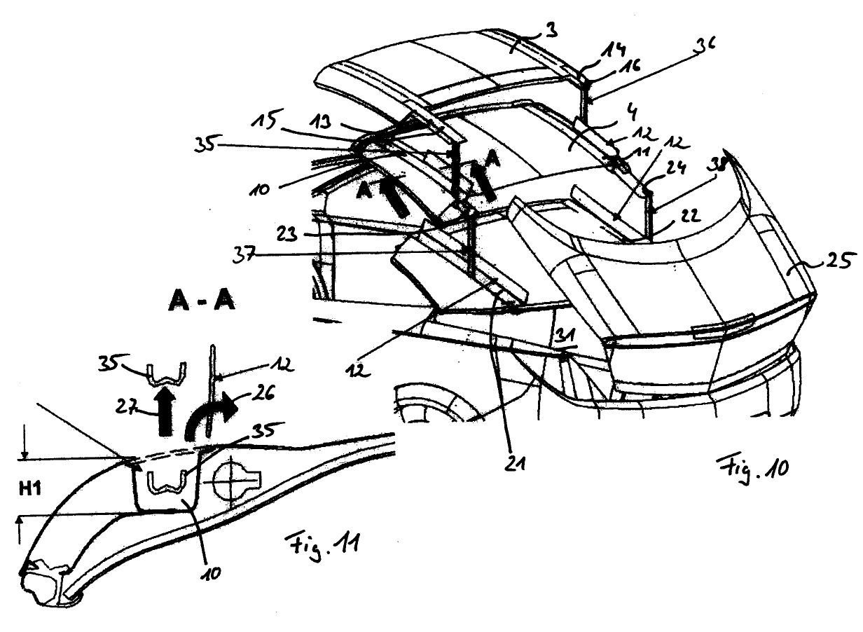

In general, roof 2 is movable between a closed position and a stored position. In the closed position (shown in FIG. 1), roof parts 3, 4, 5 extend over and cover vehicle interior 17 and are arranged flush behind one another with front roof part 3 in front of middle roof part 4 and middle roof part 4 in front of rear roof part 5 along the longitudinal direction of the vehicle. In the stored position (shown in FIG. 9), roof parts 3, 4, 5 are arranged in a stack and the roof part stack is moved to a storage compartment of the vehicle to thereby expose vehicle interior 17. As such, roof parts 3, 4, 5 are adjustable between closed and stored positions.

FIG. 1 illustrates roof 2 in the closed position. In the closed position, front roof part 3 is locked to a windshield frame 6 of vehicle 1. FIG. 9 illustrates roof 2 in the stored position. In the stored position, roof parts 3, 4, 5 are stacked upon one another and the stack is moved into a storage compartment 31 of vehicle to expose vehicle interior 17.

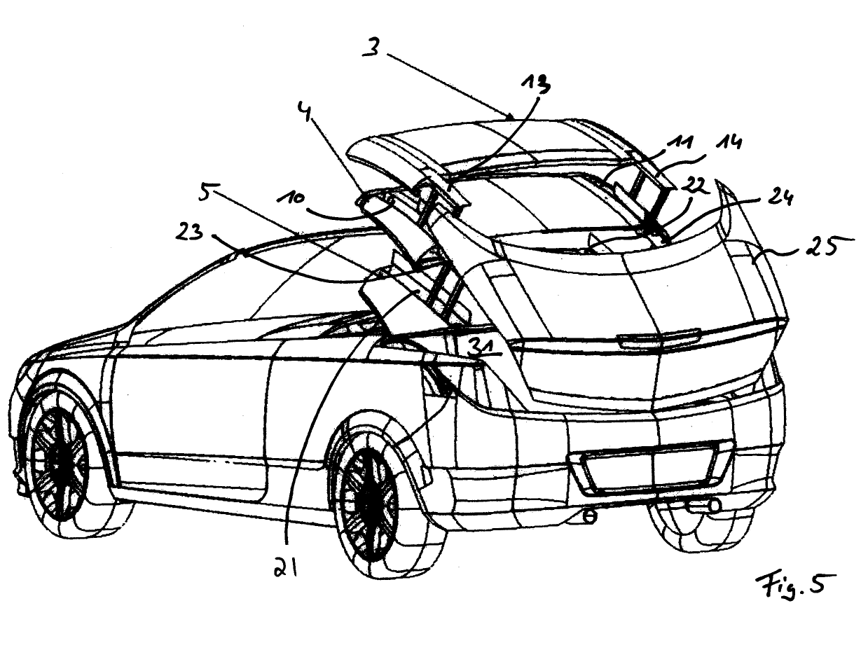

With reference to FIG. 4, a roof kinematic system is operable with roof parts 3, 4, 5 to move the roof parts relative to one another and between the closed and stored positions. The roof kinematic system includes a front kinematic system and a rear kinematic system. The front kinematic system includes a pair of front roof part kinematic systems 7. Front roof part kinematic systems 7 are arranged between front and middle roof parts 3, 4 on respective longitudinal sides of front and middle roof parts 3, 4. As such, front roof part kinematic systems 7 are spaced apart from one another in the transverse direction of vehicle 1. As such, the front kinematic system includes a left-hand side front roof part kinematic system 7 and a right-hand side rear roof part kinematic system 7. Likewise, the rear kinematic system includes a pair of rear roof part kinematic systems 8. Rear roof part kinematic systems 8 are arranged between middle and rear roof parts 4, 5 on respective longitudinal sides of middle and rear roof parts 4, 5. As such, rear roof part kinematic systems 8 are spaced apart from one another in the transverse direction of vehicle 1. As such, the rear kinematic system includes a left-hand side rear roof part kinematic system 8 and a right-hand side rear roof part kinematic system 8. Front and rear roof part kinematic systems 7, 8 are each four-bar kinematic systems.

Each front roof part kinematic system 7 includes a pair of front and rear links 7a, 7b. Links 7a, 7b of each pair are separated from one another in the longitudinal direction of vehicle 1. Likewise, each rear roof part kinematic system 8 includes a pair of front and rear links 8a, 8b. Links 8a, 8b of each pair are separated from one another in the longitudinal direction of vehicle 1.

Middle roof part 4 includes a pair of first retaining channels 10, 11 respectively along its longitudinal sides on its exterior surface 9. Retaining channels 10, 11 are formed into the sheet metal forming exterior surface 9 of middle roof part 4. Retaining channels 10, 11 longitudinally extend from front edge 18 of middle roof part 4 to rear edge 19 of middle roof part 4. As such, retaining channels 10, 11 are spaced apart from one another in the transverse direction of vehicle 1. The top sides of retaining channels 10, 11 are open. Links 7a, 7b of left-hand side front roof part kinematic system 7 extend along their length within retaining channel 10 when roof 2 is in the closed position. Likewise, links 7a, 7b of right-hand side front roof part kinematic system 7 extend along their length within retaining channel 11 when roof 2 is in the closed position. Covers 12 are respectively associated with retaining channels 10, 11. These covers 12 are articulately connected to respective longitudinal sides of middle roof part 4. These covers 12 cover retaining channels 10, 11 when roof 2 is in the closed position.

Links 7a, 7b pivot at one end within respective retaining channels 10, 11 at a distance from one another. The opposite ends of links 7a, 7b are articulately connected with respective pivoting extensions 13, 14. That is, the opposite ends of links 7a, 7b of left-hand side front roof part kinematic system 7 are articulately connected with pivoting extension 13 and the opposite ends of links 7a, 7b of right-hand side front roof part kinematic system 7 are articulately connected with pivoting extension 14. Pivoting extensions 13, 14 are located on respective longitudinal sides of front roof part 3 and, as such, as transversely separated from one another. Pivoting extensions 13, 14 project in a longitudinal direction from front roof part 3 toward and over middle roof part 4. Pivoting extensions 13, 14 each have a T-shaped cross-section respectively representing cover strips 15, 16. Cover strip 15 closes off retaining channel 10 in the area of pivoting extension 13 when roof 2 is in the closed position. Cover strip 16 closes off retaining channel 11 in the area of pivoting extension 14 when roof 2 is in the closed position.

As described, links 7a, 7b articulately connect front and middle roof parts 3, 4 to one another to move roof parts 3, 4 relative to one another and between the closed and stored positions in response to pivoting movement of links 7a, 7b.

When roof 2 is in the closed position, pivoting extensions 13, 14 are respectively held in retaining channels 10, 11 together with the respective pair of links 7a, 7b. The pivoting movement of front roof part kinematic systems 7 takes place exclusively outside vehicle interior 17. In the closed position, front roof part 3 is supported on windshield frame 6 and on middle roof part 4 via pivoting extensions 13, 14 within retaining channels 10, 11.

Middle and rear roof parts 4, 5 are articulately connected together in a manner analogous to how front and middle roof parts 3, 4 are articulately connected together. To this end, rear roof part 5 includes a pair of second retaining channels 21, 22 respectively along its longitudinal sides on its exterior surface 20. Retaining channels 21, 22 are formed into the sheet metal forming exterior surface of rear roof part 5. Retaining channels 21, 22 longitudinally extend along the length of rear roof part 5 from its front edge to its rear edge. As such, retaining channels 21, 22 are spaced apart from one another in the transverse direction of vehicle 1. The top sides of retaining channels 21, 22 are open. Retaining channels 21, 22 respectively line up with retaining channels 10, 11 in the longitudinal direction.

Links 8a, 8b of right-hand side rear roof part kinematic system 8 extend along their length within retaining channel 21 when roof 2 is in the closed position. Likewise, links 8a, 8b of left-hand side rear roof part kinematic system 8 extend along their length within retaining channel 22 when roof 2 is in the closed position. Retaining channels 21, 22 serve to hold links 8a, 8b of rear roof part kinematic systems 8. Covers 12 are respectively associated with retaining channels 21, 22. These covers 12 are articulately connected to respective longitudinal sides of rear roof part 5. These covers 12 cover retaining channels 21, 22 when roof 2 is in the closed position.

Links 8a, 8b pivot at one end on brackets (not shown) within respective retaining channels 21, 22 at a distance from one another. The opposite ends of links 8a, 8b are articulately connected with respective pivoting extensions 23, 24. That is, the opposite ends of links 8a, 8b of left-hand side rear roof part kinematic system 8 are articulately connected with pivoting extension 23 and the opposite ends of links 8a, 8b of right-hand side rear roof part kinematic system 8 are articulately connected with pivoting extension 24. Pivoting extensions 23, 24 are located on respective longitudinal sides of middle roof part 4 and, as such, as transversely separated from one another. Pivoting extensions 23, 24 project in a longitudinal direction from middle roof part 4 toward and over rear roof part 5. Pivoting extensions 23, 24 do not have top cover strips.

As described, links 8a, 8b articulately connect middle and rear roof parts 4, 5 to one another to move roof parts 4, 5 relative to one another and between the closed and stored positions in response to pivoting movement of links 8a, 8b.

When roof 2 is in the closed position, pivoting extensions 23, 24 are respectively held in retaining channels 21, 22 together with the respective pair of links 8a, 8b. The pivoting movement of rear roof part kinematic systems 8 takes place exclusively outside vehicle interior 17. In the closed position, middle roof part 4 is supported on rear roof part 5 via pivoting extensions 23, 24 within retaining channels 21, 22.

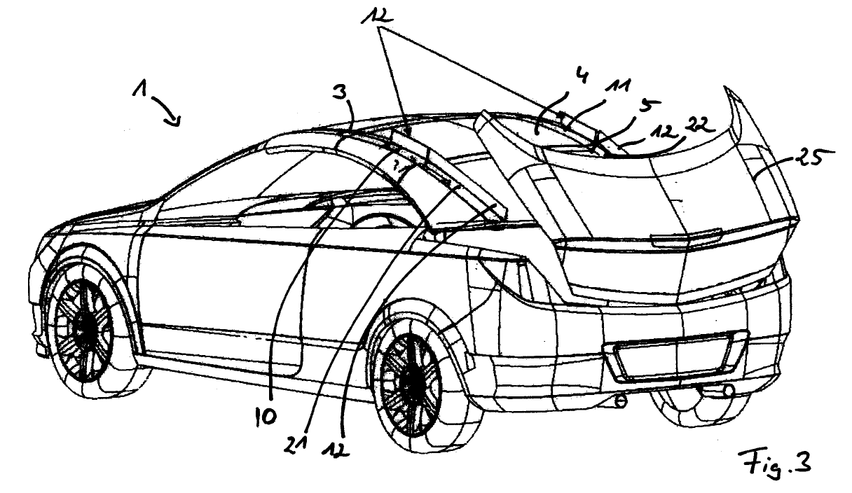

FIG. 2 illustrates a sectional illustration through middle roof part 4 along the line A-A shown in FIG. 1. Retaining channel 10 for holding links 7a, 7b of left-hand side front roof part kinematic system 7 runs in the longitudinal direction of vehicle 1 as shown. Depth H of retaining channel 10 corresponds to at least the sum of the heights of links 7a, 7b. FIG. 2 shows the position of links 7a, 7b in the closed position on exterior surface 9 of middle roof part 4 or, more precisely, within retaining channel 10. Cover 12 associated with retaining channel 10 folds in the direction of arrow 26 to cover retaining channel 10. This cover 12 unfolds in the direction of arrow 26 to expose retaining channel 10 in the upward direction. After this cover 12 is unfolded, the cover assumes the vertical position shown in the dashed lines of FIG. 2. Links 7a, 7b can then be swung out of retaining channel 10 in the direction of arrow 27 to move roof 2 toward the storage position.

As further shown in FIG. 2, a hollow space 28 is between exterior surface 9 of middle roof part 4 and an inner roof panel 29 bordering vehicle interior 17. A drive 30 is arranged within hollow space 28. Drive 30 is in the form of a rotary actuator. Drive 30 pivots links 7a, 7b of left-hand side front roof part kinematic system 7. Drive 30 is transversely located from retaining channel 10 toward the direction of vehicle interior 17 as shown in FIG. 2.

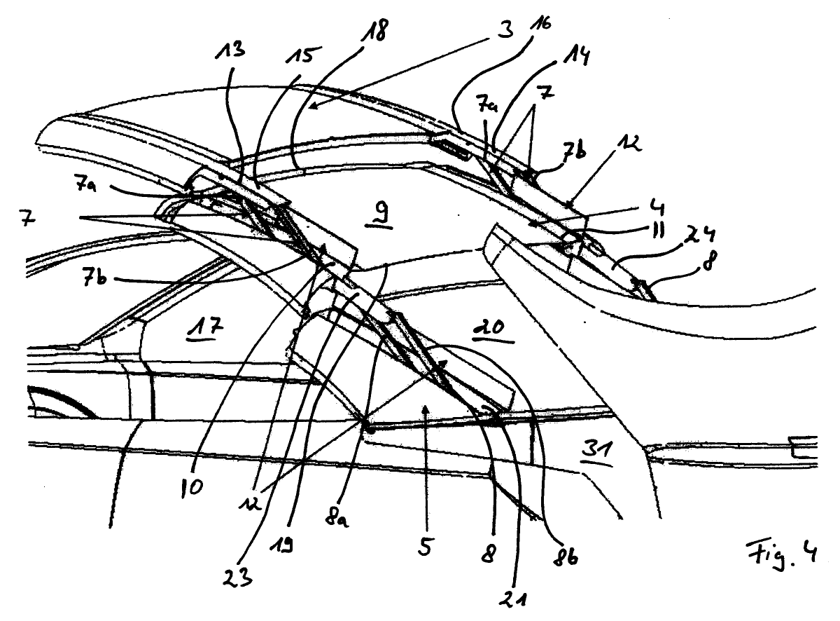

FIG. 3 illustrates roof parts 3, 4, 5 in the closed position. Covers 12 for closing retaining channels 10, 11, 21, 22 have been pivoted out of their horizontal (i.e., covering) position into their vertical (i.e., opening) position such that retaining channels 10, 11, 21, 22 are open in the upward direction. This allows front and rear roof part kinematic systems 7, 8 to pivot out of the closed position toward the outside. Front and rear roof part kinematic systems 7, 8 do not encroach upon vehicle interior 17 when pivoting between the closed and storage positions. The entire pivoting movement of roof part kinematic systems 7, 8 takes place outside vehicle interior 17 as no component of roof part kinematic systems 7, 8 projects into vehicle interior 17. As further shown in FIG. 4, roof part kinematic systems 7, 8 are arranged on the outside of roof parts 3, 4, 5 and do not encroach on the passengers' headroom.

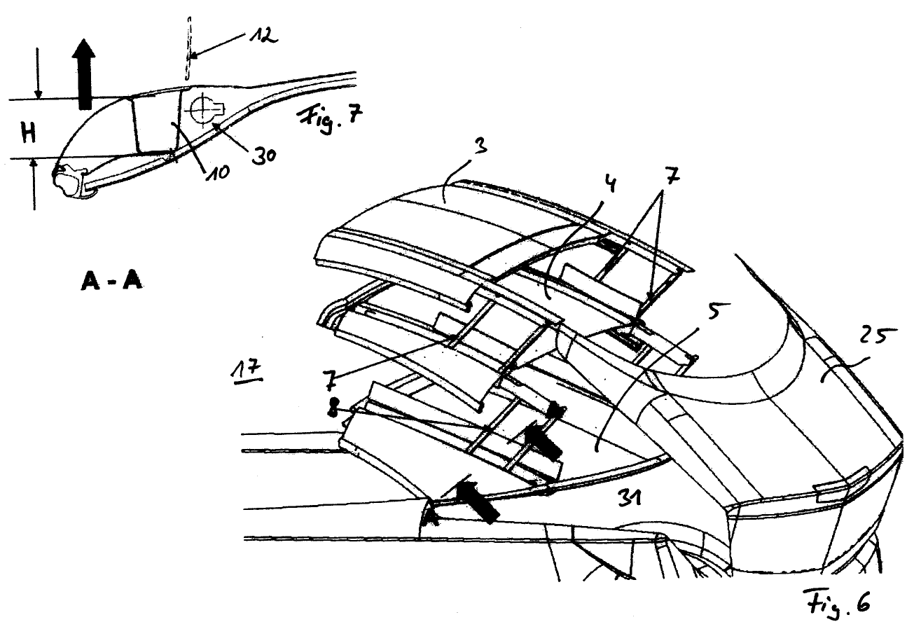

FIG. 4 illustrates a first intermediate position of roof 2 between the closed and storage positions. FIG. 5 illustrates a second intermediate position of roof 2 between the closed and storage positions during the adjustment motion of roof 2 out of the closed position. The second intermediate position of roof 2 shown in FIG. 5 is more advanced to the storage position than the first intermediate position shown in FIG. 4. In FIG. 5, roof parts 3, 4, 5 have not yet been laid on top of one another. Links 7a, 7b and 8a, 8b of roof part kinematic systems 7, 8 are oriented almost perpendicular to middle and rear roof parts 4, 5. Pivoting extensions 13, 14 and 23, 24 are raised out of retaining channels 10, 11 and 21, 22 and pivoted in a combined rotary/translational movement in the direction toward the rear of vehicle 1.

FIG. 6 illustrates roof 2 in a third intermediate position of roof 2 between the closed and storage positions during the adjustment motion of roof 2 out of the closed position. The third intermediate position of roof 2 shown in FIG. 6 is more advanced to the storage position than the second intermediate position shown in FIG. 5. In FIG. 6, roof parts 3, 4, 5 have almost been put in a stack and vehicle interior 17 is almost completely exposed.

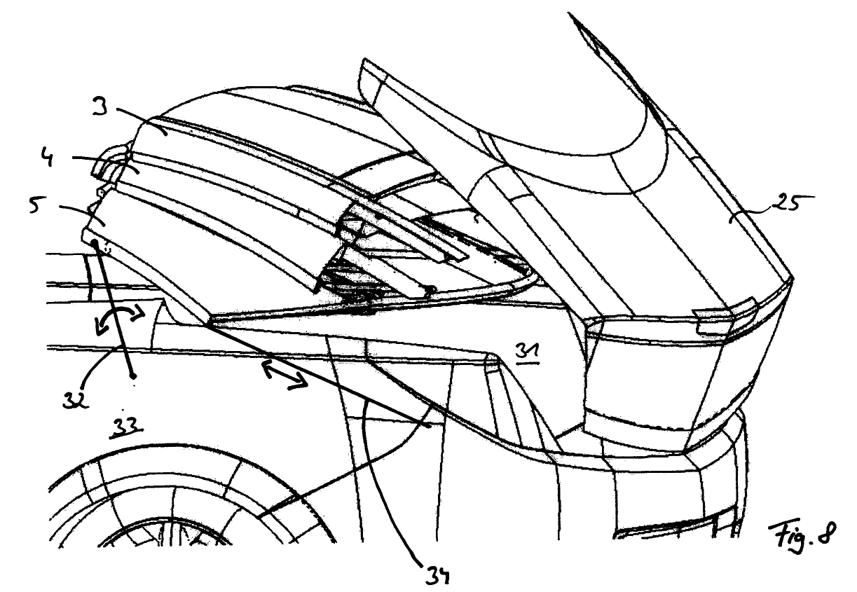

FIG. 7 illustrates a sectional illustration along line A-A of FIG. 6. Cover 12 associated with retaining channel 10 has been folded up to thereby expose retaining channel 10 toward the top. No links 7a, 7b can be seen within retaining channel 10, as links 7a, 7b have been pivoted upward about the axes of rotation running in the transverse direction through retaining channel 10 moving roof parts 3, 4, 5 in the direction of the storage position.

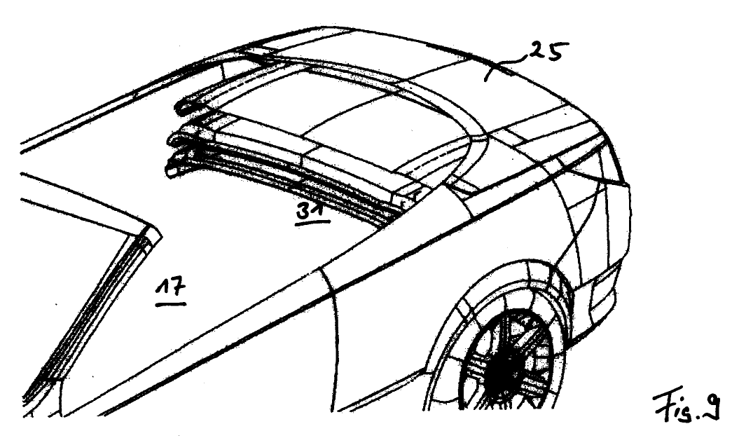

FIG. 8 illustrates roof 2 in a fourth intermediate position of roof 2 between the closed and storage positions during the adjustment motion of roof 2 out of the closed position. The fourth intermediate position of roof 2 shown in FIG. 8 is more advanced to the storage position than the third intermediate position shown in FIG. 6. In FIG. 8, roof parts 3, 4, 5 have reached their stacked position with roof parts 3, 4, 5 laid in same direction. Now the stack of roof parts 3, 4, 5 is to be conveyed into storage compartment 30 with convertible top compartment cover 25 open. A pivoting lever 32 pivots at one end on vehicle body 33 and at its other end in the front area of rear roof part 5. Making pivoting lever 32 pivot clockwise in the plane of FIG. 8 causes the stack of roof parts 3, 4, 5 to slide along a guide rail 34 into storage compartment 31.

FIG. 9 illustrates roof 2 in the storage position with roof parts 3, 4, 5 being stacked in the same direction and stowed in storage compartment 31 of vehicle 1. Convertible top compartment cover 25 is closed over storage compartment 21 and vehicle interior 17 is completely exposed.

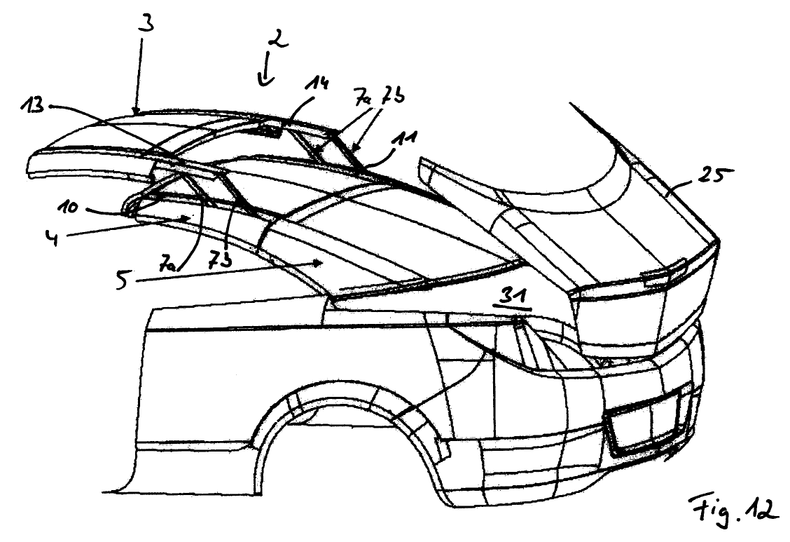

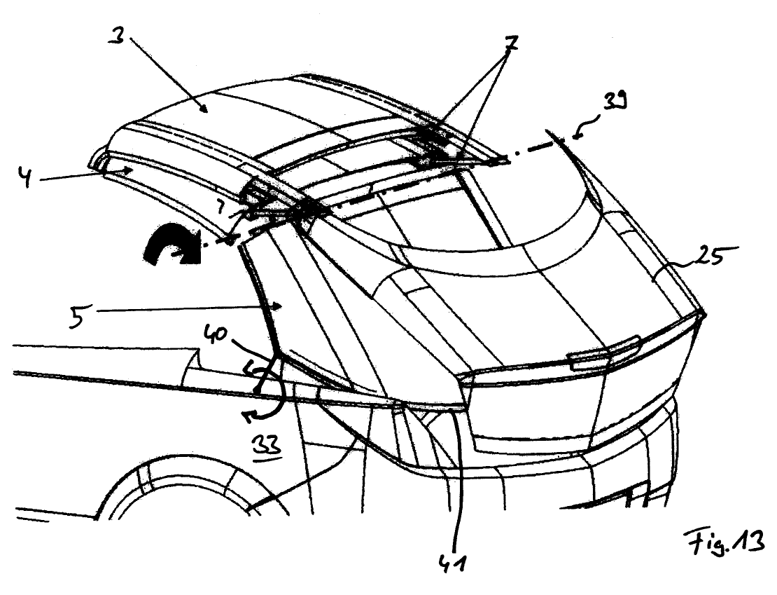

Referring now to FIGS. 10 and 11, roof 2 in accordance with a second embodiment of the present invention is shown. FIG. 10 illustrates roof 2 in an intermediate position between the closed and storage positions. In general, in the second embodiment, front and rear roof part kinematic systems 7, 8 each include a single four-bar kinematic system. Each four-bar kinematic system is formed of two individual links that are separated in the transverse and longitudinal directions of vehicle 1.

More particularly, front roof part kinematic system 7 is between front and middle roof parts 3, 4 and includes two individual front links 35, 36. Front links 35, 36 are separated from one another in both the transverse and longitudinal directions of vehicle 1. Front links 35, 36 are articulately connected with front roof part 3, each being attached in the rear end area of pivoting extensions 13, 14. Pivoting extension 13 on the left-hand side is longer than pivoting extension 14 on the right-hand side. This asymmetric design of front roof part kinematic system 7 allows retaining channels 10, 11 to be flatter than is the case with the embodiment in FIGS. 1 through 9, as each retaining channel 10, 11 hold only one of links 35, 36.

Likewise, rear roof part kinematic system 8, which is between middle and rear roof parts 4, 5, includes two individual rear links 37, 38. Rear links 37, 38 are separated from one another in both the transverse and longitudinal directions of vehicle 1. Rear links 37, 38 when taken together form a single four-bar kinematic system overlapping the longitudinal sides. Rear links 37, 38 are articulately connected with the rear end areas of pivoting extensions 23, 24 of middle roof part 4. Pivoting extension 23 on the left-hand side is shorter than pivoting extension 24 on the right-hand side. Thus, there is one longer and one shorter pivoting extension 13, 23 and 14, 24 on each longitudinal side.

In the closed position, when links 35, 36, 37, 38 are respectively stored within retaining channels 10, 11, 21, 22, covers 12 associated with the retaining channels can close off the retaining channels. Sections of retaining channels 10, 11 on the outside of middle roof part 4 can be closed by cover strips 15, 16 of pivoting extensions 13, 14.

FIG. 11 illustrates a sectional view along the line A-A in FIG. 10. FIG. 11 illustrates front link 35 inside retaining channel 10 and also illustrates front link 35 pivoted upward in the direction of arrow 27 to describe the relatively small height H1 of retaining channel 10. H1 of each retaining channel is due to the fact that only one individual link is held in the retaining channel.

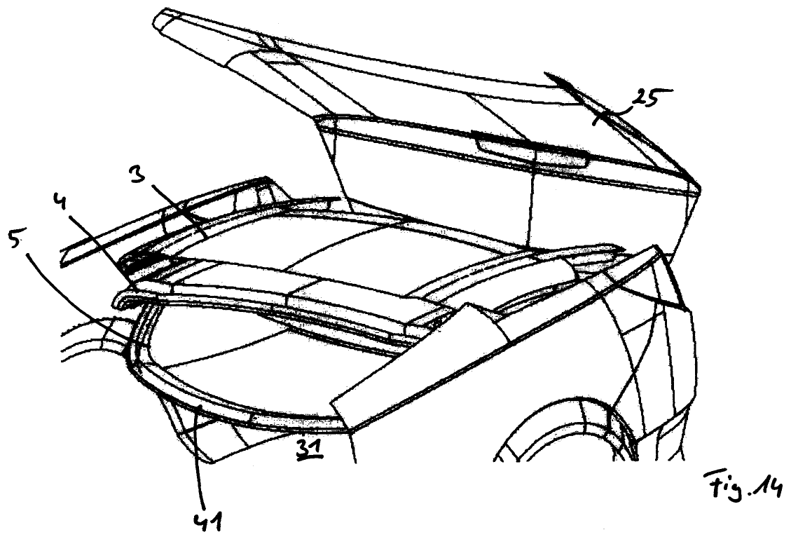

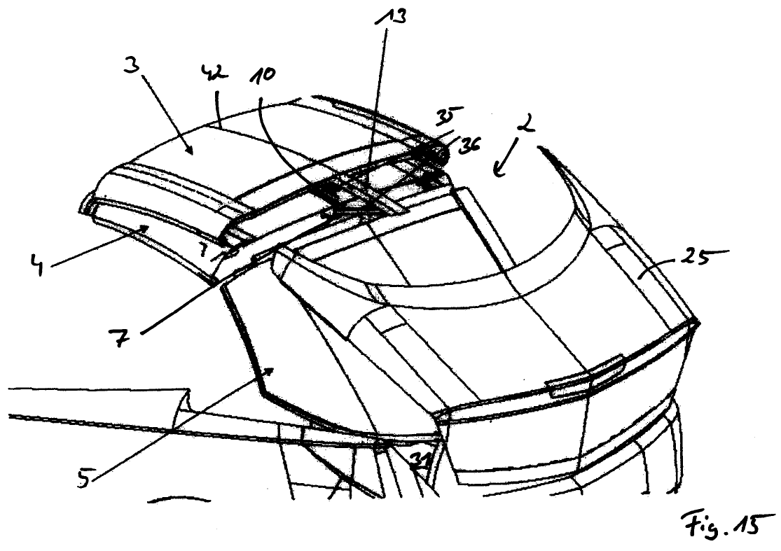

Referring now to FIGS. 12, 13, and 14, roof 2 in accordance with a third embodiment of the present invention is shown. FIG. 12 illustrates roof 2 in an intermediate position between the closed and storage positions; FIG. 13 illustrates roof 2 in an intermediate position more advanced to the storage position; and FIG. 14 illustrates roof 2 in the storage position within storage compartment 31. In general, in the third embodiment, front and the middle roof parts 3, 4 can be laid in the same direction and rear roof part 5 can be laid in the opposite direction to front and middle roof parts 3, 4 when roof 2 is in the storage position.

Front and middle roof parts 3, 4 are articulately connected together as described with reference to FIGS. 1 through 9. Rear roof part 5 is articulately connected with middle roof part 4 in such a way that rear roof part 5 can be stored in storage compartment 31 in the opposite direction to roof parts 3, 4 as can be seen from FIG. 14. In FIG. 12, front roof part 3 is pivoted in a rotary/translational movement up out of its closed position and in the direction toward the rear of vehicle 1 by front roof part kinematic system 7 located outside vehicle interior 17. Links 7a, 7b of front roof part kinematic system 7 are raised out of retaining channels 10, 11 as are pivoting extensions 13, 14 of front roof part 3 which are articulately connected with links 7a, 7b. At the point in time shown in FIG. 12, there has not yet been relative movement between middle and rear roof parts 4, 5.

In FIG. 13, front roof part 3 is laid on middle roof part 4 in the same direction and together form a stack of roof parts. Rear roof part 5 is raised out of the closed position and pivoted, with respect to the stack of roof parts 3, 4, about an axis of rotation 39 running in the transverse direction of vehicle 1. To execute this pivoting movement, a rotary handle 40 pivots at one end on rear roof part 5 and at its other end vehicle body 33. An actuator (not shown) actuates rotary handle 40 to pivot.

FIG. 14 illustrates when roof 2 is in the closed position how roof parts 3, 4, 5 are stored in a roof part stack within storage compartment 31 when convertible top compartment cover 25 is still open. Rear roof part 5 is stored in the opposite direction to roof parts 3, 4. To accomplish this, rear roof part 5 is pivoted still farther about axis of rotation 39. The rear end 41 of rear roof part 5 points in the forward direction of vehicle travel when roof 2 is in the storage position.

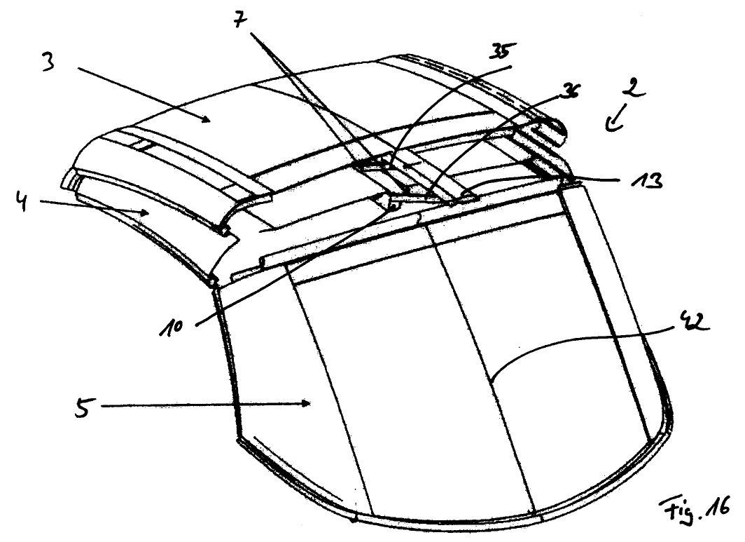

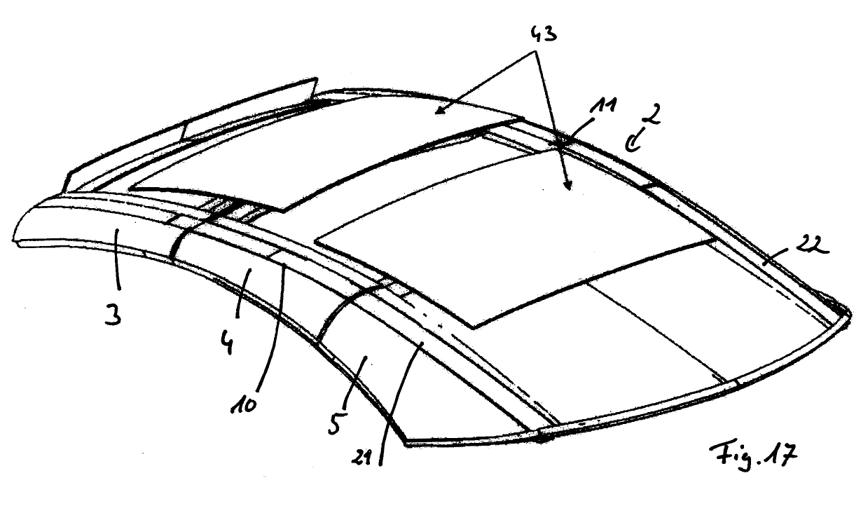

Referring now to FIGS. 15 and 16, roof 2 in accordance with a fourth embodiment of the present invention is shown. In general, in the fourth embodiment, front roof part kinematic system 7 between front and middle roof parts 3, 4 is formed of a single four-bar kinematic system including two links 35, 35 separated in the direction of travel which are arranged on the longitudinal central axis of roof 2.

The fourth embodiment as shown in FIGS. 15 and 16 corresponds to the embodiment shown in FIGS. 12, 13, and 14, as far as the pivoting of rear roof part 5 on vehicle body 33 and on middle roof part 4 is concerned. As shown in FIG. 15, a single four-bar kinematic system 7 is between front and middle roof parts 3, 4. Kinematic system 7 has two links 35, 36. Links 35, 36 are separated from one another in the longitudinal direction of vehicle 1. Kinematic system 7 is arranged on the longitudinal central axis 42 of roof 2. Links 35, 36 pivot at one end in retaining channel 10 centrally arranged on middle roof part 4 and running in the longitudinal direction of vehicle 1. Furthermore, links 35, 36 are articulately connected with a pivoting extension 13 of front roof part 3 projecting in the direction of middle roof part 4. In the closed position, pivoting extension 13 is held in retaining channel 10. No additional lateral support of front roof part 3 is provided. Additional lateral support links are conceivable, however force should be applied to kinematic system 7 located on longitudinal central axis 42.

FIG. 16 illustrates roof 2 of FIG. 15 detached and enlarged. Front and middle roof parts 3, 4 form a stack of roof parts. In the storage position, rear roof part 5 is stored in storage compartment 31 in the opposite direction to front and middle roof parts 3, 4.

Referring now to FIG. 17, roof 2 in accordance with a fifth embodiment of the present invention is shown. In the closed position, roof part kinematic systems for adjustment of front and middle roof parts 3, 4 are held in retaining channels 10, 11 and 21, 22. Front and middle roof parts 3, 4 have sunroof parts 43 built into them. Sunroof parts 43 are designed to be movable in the longitudinal direction of vehicle 1 from one roof part to another. For example, sunroofs 43 can be pushed onto rear roof part 5, each exposing an opening in front and middle roof parts 3, 4. A roof made in such a way can be operated in coupe position, in convertible position, and with open sunroof parts 43. A folding wind deflector running in the vehicle's transverse direction is at the front edge of front roof part 3.

### List of Reference Numbers 1 Vehicle 2 Hardtop vehicle roof 3 Front roof part 4 Middle roof part 5 Rear roof part 6 Windshield frame 7 Front roof part kinematic system 7a Front link 7b Rear link 8 Rear roof part kinematic system 8a Front link 8b Rear link 9 Exterior surface of middle roof part 10 Retaining channel 11 Retaining channel 12 Cover 13 Pivoting extension 14 Pivoting extension 15 Cover strip 16 Cover strip 17 Vehicle interior 18 Front edge 19 Back edge 20 Exterior surface of rear roof part 21 Retaining channel 22 Retaining channel 23 Pivoting extension 24 Pivoting extension 25 Convertible top compartment cover 26 Arrow direction 27 Arrow direction 28 Hollow space 29 Inner roof panel 30 Drive 31 Storage compartment 32 Pivoting lever 33 Vehicle body 34 Guide rail 35 Individual link 36 Individual link 37 Individual link 38 Individual link 39 Axis of rotation 40 Rotating lever 41 Back end of rear roof part 42 Longitudinal central axis 43 Sunroof parts H Height of retaining channel H1 Height of retaining channel

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A hardtop vehicle roof comprising:
at least two roof parts movable between a closed position in which the roof parts are arranged flush behind one another in a longitudinal direction to thereby cover a vehicle interior and a storage position in which the roof parts are arranged in a stack to thereby expose the vehicle interior, wherein each roof part has an exterior surface facing away from the vehicle interior in the closed position, wherein each roof part has first and second longitudinally extending sides transversely separated from one another; and
a first pair of roof part kinematic systems transversely separated from one another, one of the roof part kinematic systems articulately connecting the first sides of two of the roof parts together and the other of the roof part kinematic systems articulately connecting the second sides of the two roof parts together to move the two roof parts between the closed and storage positions, wherein in the closed position the two roof parts are arranged flush behind one another in the longitudinal direction with a first one of the two roof parts arranged in front of a second one of the two roof parts, wherein in the closed position the roof part kinematic systems are respectively arranged on the exterior surface of the second roof part on the sides of the second roof part.

2. The roof of claim 1 wherein:
the second roof part includes a pair of retaining channels, the retaining channels respectively run in the longitudinal direction on the exterior surface of the second roof part on the sides of the second roof part, wherein in the closed position the roof part kinematic systems are respectively held within the retaining channels.

3. The roof of claim 2 wherein:
the retaining channels are formed into the second roof part.

4. The roof of claim 2 wherein:
the retaining channels extend from a front edge to a back edge of the second roof part.

5. The roof of claim 2 wherein:
the second roof part includes a pair of covers respectively associated with the retaining channels, wherein the covers are openable and closable with respect to the associated retaining channels, wherein the covers close off the associated retaining channels when the covers are closed.

6. The roof of claim 1 wherein:
the roof part kinematic systems move the two roof parts such that the two roof parts lie on top of one another in the stack in the storage position.

7. The roof of claim 1 wherein:
each roof part kinematic system includes a front link and a rear link, wherein the front and rear links of the roof part kinematic systems are pivotably connected at one end to the sides of the first roof part, respectively, and are pivotably connected at their other end within the retaining channels, respectively;
wherein the front and rear links of each roof part kinematic system pivot to move the two roof parts between the closed and storage positions.

8. The roof of claim 7 wherein:
pivoting motion of the front and rear links of the roof part kinematic systems to move the two roof parts between the closed and storage positions occurs along the exterior surface of the second roof part.

9. The roof of claim 7 wherein:
the first roof part includes a pair of pivoting extensions respectively arranged on each side of the first roof part, the pivoting extensions extending longitudinally from the first roof part over the second roof part;
wherein the front and rear links of the roof part kinematic systems are pivotably connected at the one end to the pivoting extensions, respectively.

10. The roof of claim 9 wherein:
in the closed position, the pivoting extensions are respectively held within the retaining channels.

11. The roof of claim 9 wherein:
the pivoting extensions have respective cover strips which close portions of the retaining channels, respectively, in the closed position.

12. The roof of claim 1 wherein:
each roof part kinematic system includes a drive for driving the roof part kinematic systems to move the roof parts between the closed and storage positions, wherein each drive is arranged between the exterior surface of the second roof part and an inner roof panel of the second roof part.

13. The roof of claim 12 wherein:
each drive includes a rotary actuator.

14. The roof of claim 1 wherein:
each roof part kinematic system is a multiple-bar kinematic system such as a four-bar kinematic system.

15. The roof of claim 1 wherein:
the roof parts include three roof parts, wherein the first roof part is a front roof part, the second roof part is a middle roof part, and a third roof part is a rear roof part such that in the closed position the front roof part is arranged in front of the middle roof part and the middle roof part is arranged in front of the rear roof part.

16. The roof of claim 15 further comprising:
a second pair of roof part kinematic systems, wherein the first pair of roof part kinematic systems is between the front and middle roof parts to articulately connect the front and middle roof parts together and the second pair of roof part kinematic systems is between the middle and rear roof parts to articulately connect the middle and rear roof parts together;
wherein the first pair of roof part kinematic systems are respectively held in the retaining channels of the middle roof part when the roof parts are in the closed position;
wherein the second pair of roof part kinematic systems are respectively held in retaining channels of the rear roof part when the roof parts are in the closed position.

17. The roof of claim 16 wherein:
each roof part kinematic system includes a pair of links;
wherein the links of the each of the first pair of kinematic systems pivot at one end on the exterior surface of the middle roof part within the retaining channels of the middle roof part, respectively, and pivot at the other end on pivoting extensions of the front roof part, respectively, wherein the pivoting extensions of the front roof part extend over the middle roof part when the roof parts are in the closed position;
wherein the links of the each of the second pair of kinematic systems pivot at one end on the exterior surface of the rear roof part within the retaining channels of the rear roof part, respectively, and pivot at the other end on pivoting extensions of the middle roof part, respectively, wherein the pivoting extensions of the middle roof part extend over the rear roof part when the roof parts are in the closed position.

18. The roof of claim 16 wherein:
when the roof parts are in the storage position, the roof parts are laid on top of one another in a stack in same direction with the exterior surfaces of the roof parts pointing upward.

19. The roof of claim 16 wherein:
when the roof parts are in the storage position, the roof parts are laid on top of one another in a stack with the front and middle roof parts pointing in the same direction and the rear roof part pointing in an opposite direction and being at the lowest position in the stack.

20. The roof of claim 1 wherein:
at least one roof part includes a sunroof.

21. A hardtop vehicle roof comprising:
at least two roof parts movable between a closed position in which the roof parts are arranged flush behind one another in a longitudinal direction to thereby cover a vehicle interior and a storage position in which the roof parts are arranged in a stack to thereby expose the vehicle interior, wherein each roof part has an exterior surface facing away from the vehicle interior in the closed position, wherein each roof part has first and second longitudinally extending sides transversely separated from one another; and
a roof part kinematic system articulately connecting two of the roof parts together to move the two roof parts between the closed and storage positions, wherein in the closed position the two roof parts are arranged flush behind one another in the longitudinal direction with a first one of the two roof parts arranged in front of a second one of the two roof parts, wherein in the closed position the roof part kinematic system is arranged on the exterior surface of the second roof part on the sides of the second roof part.

22. The roof of claim 21 wherein:
the roof part kinematic system includes two individual links which are respectively arranged on the exterior surface of the second roof part on the sides of the second roof part when the roof parts are in the closed position, wherein each link articulately connects the first and second roof parts together.

23. The roof of claim 22 wherein:
the links are longitudinally and transversely separated from one another.

24. The roof of claim 22 wherein:
the second roof part includes a pair of retaining channels, the retaining channels respectively run in the longitudinal direction on the exterior surface of the second roof part on the sides of the second roof part, wherein in the closed position the links of the roof part kinematic system are respectively held within the retaining channels.

25. The roof of claim 22 wherein:
the second roof part includes a common retaining channel, the common retaining channel runs in the longitudinal direction on the exterior surface of the second roof part, wherein in the closed position the links of the roof part kinematic system are held within the common retaining channel.

26. The roof of claim 22 wherein:
the links are arranged on a longitudinal central axis of the second roof part.

27. A hardtop vehicle roof comprising:
at least two roof parts movable between a closed position in which the roof parts are arranged flush behind one another in a longitudinal direction to thereby cover a vehicle interior and a storage position in which the roof parts are arranged in a stack to thereby expose the vehicle interior, wherein each roof part has an exterior surface facing away from the vehicle interior in the closed position, wherein each roof part has first and second longitudinally extending sides transversely separated from one another; and
a roof part kinematic system articulately connecting two of the roof parts together to move the two roof parts between the closed and storage positions, wherein in the closed position the two roof parts are arranged flush behind one another in the longitudinal direction with a first one of the two roof parts arranged in front of a second one of the two roof parts, wherein in the closed position the roof part kinematic system is arranged on the exterior surface of the second roof part on the longitudinal central axis of the second roof part.
